(19) United States
(12) Patent Application Publication
(10) Pub. No.: US 2004/0084581 A1
(43) Pub. Date: May 6, 2004

(54) Collapsible support for workbenches

(76) Inventor: Lee-Cheng Chang, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/287,732

(22) Filed: Nov. 4, 2002

(51) Int. Cl. F16M 11/38

(52) U.S. Cl. 248/166

(57) ABSTRACT

A collapsible support includes at least three legs and a corresponding number of collapsible X-shaped structures each connected between adjacent two of the legs. Each of the collapsible X-shaped structures includes two connectors each having a lower end connected with one of the legs and an upper end connected with another one of the legs. Each of the X-shaped structures includes two lower joints connected between one of the legs and the lower end of one of the connectors and two upper joint connected between one of the legs and the upper end of one of the connectors. Each of the lower joints includes a sleeve for receiving one of the legs and a tab formed on the sleeve and connected with the lower end of one of the connectors. The lower joint includes a foot attached to the lower end of each of the legs. Each of the upper joints includes a sleeve for receiving one of the legs and a tab formed on the sleeve and connected with the upper end of one of the connectors. Each of the connectors is a strip or a tube. The support includes a number of stages each secured to an upper end of one of the legs. Each of the stages defines a slot for receiving a threaded bolt extending from a workbench.

### BACKGROUND OF INVENTION

1. Field of Invention

The present invention relates to workbenches and, more particularly, to a collapsible support for workbenches with different sizes.

2. Related Prior Art

Referring to FIG. 9, two conventional workbenches 5 and 6 are shown. The workbench 5 is mounted on a support 1 including four legs 3. The workbench 6 is mounted on a support 2 including four legs 4. The area of the workbench 5 is smaller than the area of the workbench 6. Accordingly, the distance between two adjacent legs 3 is shorter than the distance between two adjacent legs 4. The legs 3 are longer than the legs 4. The supports 1 and 2 both include a rigid configuration and a constant size. Therefore, each of the supports 1 and 2 is only suitable for supporting a workbench. When two workbenches with different sizes are needed, two supports must be carried. It is troublesome to carry two supports. Even when only one workbench is needed, it is still troublesome to carry a support with a fixed configuration.

The present invention is therefore intended to obviate or at least alleviate the problems encountered in prior art.

### SUMMARY OF INVENTION

It is an objective of the present invention to provide a workbench support with an adjustable size.

It is another objective of the present invention to provide a workbench support with a collapsible configuration.

According to the present invention, a collapsible support includes at least three legs and a corresponding number of collapsible X-shaped structures each connected between adjacent two of the legs. Each of the collapsible X-shaped structures includes two connectors each having a lower end connected with one of the legs and an upper end connected with another one of the legs. Each of the X-shaped structures includes two lower joints connected between one of the legs and the lower end of one of the connectors and two upper joint connected between one of the legs and the upper end of one of the connectors. Each of the lower joints includes a sleeve for receiving one of the legs and a tab formed on the sleeve and connected with the lower end of one of the connectors. The lower joint includes a foot attached to the lower end of each of the legs. Each of the upper joints includes a sleeve for receiving one of the legs and a tab formed on the sleeve and connected with the upper end of one of the connectors. Each of the connectors is a strip or a tube. The support includes a number of stages each secured to an upper end of one of the legs. Each of the stages defines a slot for receiving a threaded bolt extending from a workbench.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings.

FIG. 1 is a perspective view of a collapsible support for workbenches according to a first embodiment of the present invention.

FIG. 2 is a perspective view of the collapsible support of FIG. 1 in a first extended position for supporting a first workbench.

FIG. 3 is a side view of the workbench mounted on the support of FIG. 2.

FIG. 4 is a perspective view of the collapsible support of FIG. 1 in a second position for supporting a second workbench.

FIG. 5 is a side view of the workbench mounted on the support of FIG. 4.

FIG. 6 is a perspective view of the collapsible support of FIG. 1 in a collapsed position.

FIG. 7 is a perspective view of a collapsible support for workbenches according to a second embodiment of the present invention.

FIG. 8 is a perspective view of a collapsible support for workbenches according to a third embodiment of the present invention.

FIG. 9 is a perspective view of two conventional rigid supports for workbenches.

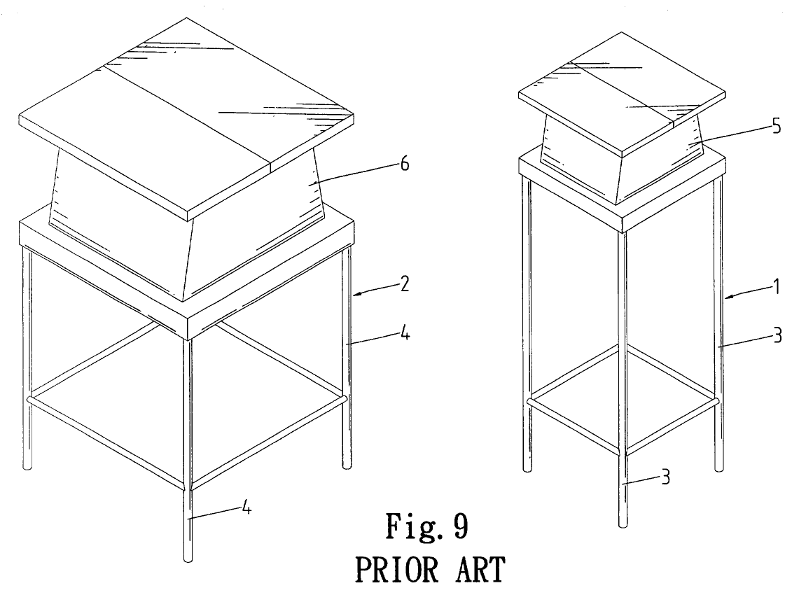

### DETAILED DESCRIPTION OF EMBODIMENTS

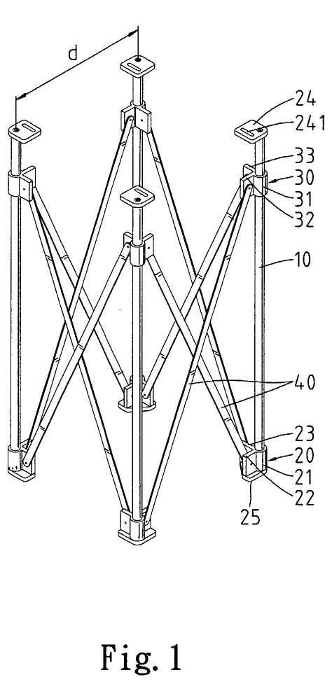

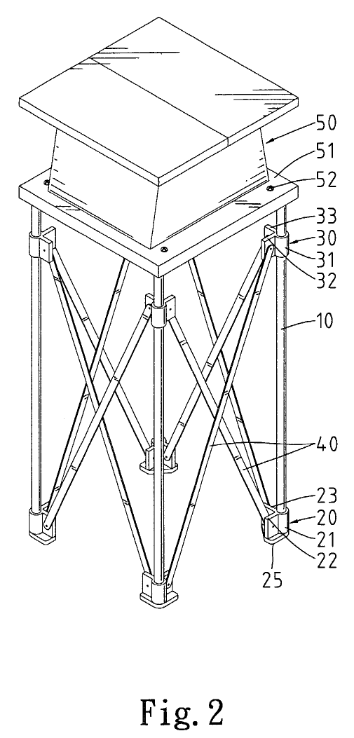

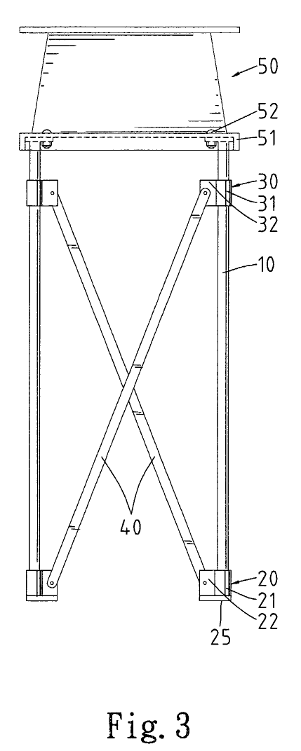

Referring to FIGS. 1-8, according to the present invention, a collapsible support for benches includes at least three legs and, more particularly, four legs in these figures.

Referring to FIGS. 1-6, according to a first embodiment of the present invention, a collapsible support includes four legs 10 on each of which a lower joint 20 and an upper joint 30 are mounted.

Each of the lower joints 20 includes a sleeve 21 for receiving one of the legs 10, two tabs 22 and 23 extending from the sleeve 21 and a foot 25 formed beneath the sleeve 21 and the tabs 22 and 23. The angle between the tabs 22 and 23 is determined based on the number of legs 10. If a collapsible support includes four legs 10, the angle between the tabs 22 and 23 is ninety degrees. If a collapsible support includes three legs 10, the angle between the tabs 22 and 23 is sixty degrees.

Each of the upper joints 30 includes a sleeve 31 for receiving one of the legs 10 and two tabs 32 and 33 extending from the sleeve 31. The angle between the tabs 32 and 33 is determined based on the number of legs 10. If a collapsible support includes four legs 10, the angle between the tabs 32 and 33 is ninety degrees. If a collapsible support includes three legs 10, the angle between the tabs 32 and 33 is sixty degrees.

The lower joints 20 are identical to the upper joints 30 except that each of the lower joints 20 includes a foot 25 formed between beneath a sleeve and two tabs.

A connector 40 includes a lower end connected with the tab 22 of the lower joint 20 mounted on each of the legs 10 by means of a pin (not numbered) and an upper end connected with the tab 32 of the upper joint 30 mounted on the next one of the legs 10 by means of a pin (not numbered). Thus, a collapsible X-shaped structure is formed between two adjacent ones of the legs 10. Accordingly, the distance d between two adjacent ones of the legs 10 is adjustable. Each of the connectors 40 is in the form a strip.

A stage 24 is secured to an upper end of each of the legs 10 by means of a threaded bolt or screw (not numbered). Each of the stages 24 defines a slot 241.

Referring to FIGS. 1-3, the collapsible support is in a first extended position for supporting a first workbench 50. The first workbench 50 includes a base 51 through which four holes (not numbered) extend. A threaded bolt 52 is driven through each of the holes extending through the base 51 and the slot 241 defined in one of the stages 24 into engagement with a threaded nut 53 for securing the first workbench 50 to the collapsible support.

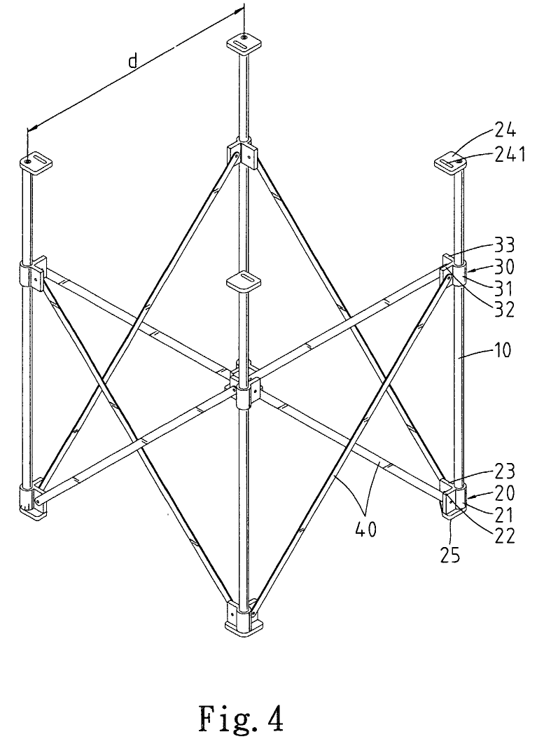

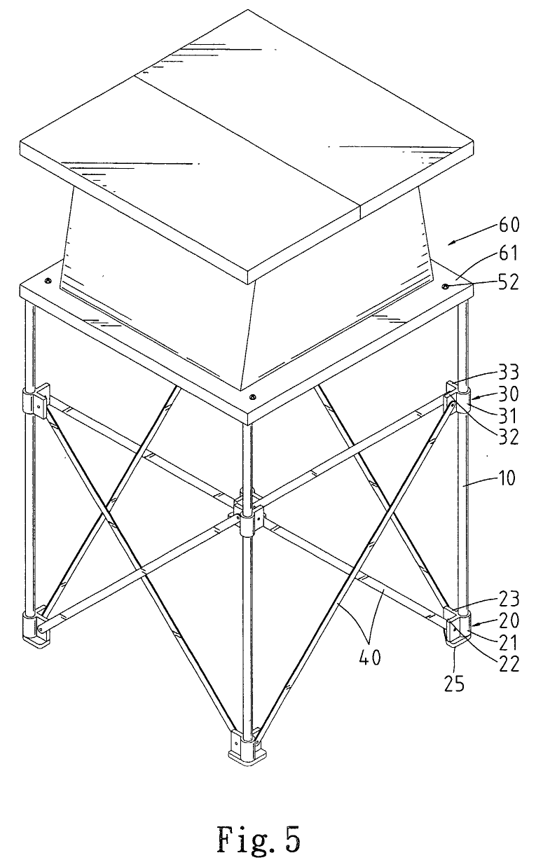

Referring to FIGS. 4 and 5, the collapsible support is in a second extended position for supporting a second workbench 60. The second workbench 60 includes a base 61 through which four holes (not numbered) extend. A threaded bolt 52 is driven through each of the holes extending through the base 61 and the slot 241 defined in one of the stages 24 into engagement with a threaded nut 53 for securing the second workbench 50 to the collapsible support.

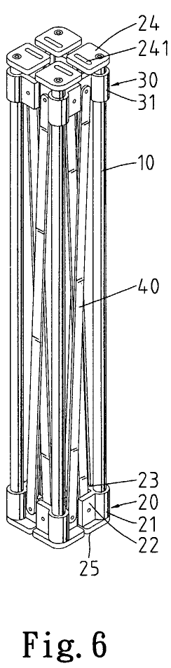

Referring to FIG. 6, the collapsible is in a collapsed position for convenient storage and transportation.

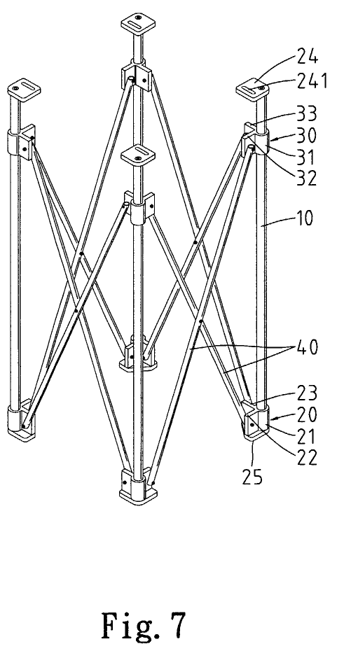

Referring to FIG. 7, a collapsible support according to a second embodiment of the present invention is shown. The second embodiment is identical to the first embodiment except that each of the connectors 40 is in the form a tube.

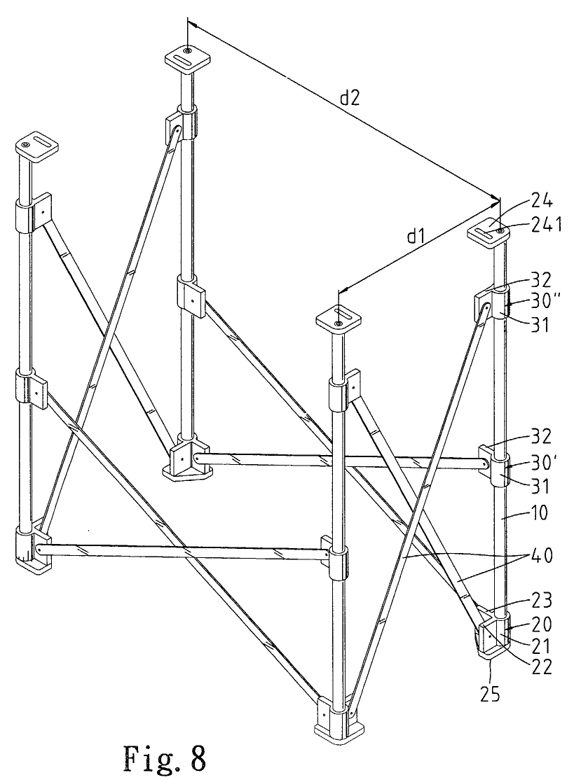

Referring to FIG. 8, a collapsible support according to a third embodiment of the present invention is shown. The third embodiment is identical to the first embodiment except that an intermediate joint 30′ and an upper joint 30″, instead of a single upper joint 30, are mounted on each of the legs 10 and that the intermediate joint 30′ and the upper joint 30″ both include only one tab 32 instead of two tabs 32 and 33. For convenience of description, the legs 10 will be referred to as first, second, third and fourth legs sequentially.

One of the connectors 40 includes a lower end connected with the tab 22 of the lower joint 20 mounted on the first leg 10 and an upper end connected with the tab 32 of the upper joint 30″ mounted on the second leg 10. Another one of the connectors 40 includes an upper end connected with the tab 32 of the upper joint 30″ mounted on the first leg 10 and a lower end connected with the tab 22 of the lower joint 20 mounted on the second leg 10. Thus, a collapsible X-shaped structure is formed between the first and second legs 10 that are away from each other by a distance d1.

Another one of the connectors 40 includes a lower end connected with the tab 22 of the lower joint 20 mounted on the second leg 10 and an upper end connected with the tab 32 of the intermediate joint 30′ mounted on the third leg 10. Another one of the connectors 40 includes an upper end connected with the tab 32 of the intermediate joint 30′ mounted on the second leg 10 and a lower end connected with the tab 22 of the lower joint 20 mounted on the third leg 10. Thus, a collapsible X-shaped structure is formed between the second and third legs 10 that are away from each other by a distance d2.

Similarly, the third and fourth legs 10 are connected with and at the distance d1 from each other. The fourth and first legs 10 are connected with and at the distance d2 from each other. The distance d1 is equal to or different from the distance d2. In the case where the distance d1 is different from the distance d2, the stages 24 in the third embodiment define a rectangular plane instead of a square plane defined by the stages 24 in the first embodiment.

The present invention has been described via illustration of some embodiments. After a study of this specification, those skilled in the art can derive various variations from the embodiments. Therefore, the embodiments are only taken as examples and shall not limit the scope of the present invention defined in the following claims.

1. A collapsible support including at least three legs and a corresponding number of collapsible X-shaped structures each connected between adjacent two of the legs.

2. The collapsible support according to claim 1 wherein each of the collapsible X-shaped structures includes two connectors each having a lower end connected with one of the legs and an upper end connected with another one of the legs.

3. The collapsible support according to claim 2 wherein the lower end of each of the connectors is pivotally connected with one of the legs.

4. The collapsible support according to claim 3 wherein the upper end of each of the connectors is movably and pivotally connected with one of the legs.

5. The collapsible support according to claim 2 wherein the lower end of each of the connectors is movably and pivotally connected with one of the legs.

6. The collapsible support according to claim 3 wherein the upper end of each of the connectors is pivotally connected with one of the legs.

7. The collapsible support according to claim 2 wherein each of the X-shaped structures includes two lower joints each connected between one of the legs and the lower end of one of the connectors and two upper joint each connected between one of the legs and the upper end of one of the connectors.

8. The collapsible support according to claim 7 wherein each of the lower joints includes a sleeve for receiving one of the legs and a tab formed on the sleeve and connected with the lower end of one of the connectors.

9. The collapsible support according to claim 7 wherein the lower joint includes a foot attached to the lower end of each of the legs.

10. The collapsible support according to claim 7 wherein each of the upper joints includes a sleeve for receiving one of the legs and a tab formed on the sleeve and connected with the upper end of one of the connectors.

11. The collapsible support according to claim 2 wherein each of the connectors is a strip.

12. The collapsible support according to claim 2 wherein each of the connectors is a tube.

13. The collapsible support according to claim 1 including a number of stages each secured to an upper end of one of the legs for supporting a workbench.

14. The collapsible support according to claim 13 wherein each of the stages defines a slot for receiving a threaded bolt extending from the workbench.

15. A collapsible support including four legs and four collapsible X-shaped structures each connected between adjacent two of the legs.

16. The collapsible support according to claim 15 wherein each of the collapsible X-shaped structures includes two connectors each including a lower end connected with one of the legs and an upper end connected with another one of the legs.

17. The collapsible support according to claim 16 wherein each of the X-shaped structures includes two lower joints each including a sleeve for receiving one of the legs and a tab pivotally connected with the lower end of one of the connectors and two upper joints each including a sleeve for receiving one of the legs and a tab pivotally connected with the upper end of one of the connectors.

18. The collapsible support according to claim 17 wherein two upper joints are mounted on each of the legs.

19. The collapsible support according to claim 18 wherein a single lower joint is mounted on each of the legs and includes two tabs.
